(19) United States
(12) Patent Application Publication
(10) Pub. No.: US 2013/0236155 A1
(43) Pub. Date: Sep. 12, 2013

(54) AUDIO GUIDING DEVICE AND AUDIO GUIDING METHOD

(71) Applicants: Tien-Ping LIU, Tu-Cheng (TW); Pei-Yun TSAI, Tu-Cheng (TW)

(72) Inventors: Tien-Ping LIU, Tu-Cheng (TW); Pei-Yun TSAI, Tu-Cheng (TW)

(73) Assignee: HON HAI PRECISION INDUSTRY CO., LTD., Tu-Cheng (TW)

(21) Appl. No.: 13/593,528

(22) Filed: Aug. 24, 2012

(30) Foreign Application Priority Data
Mar. 9, 2012 (TW) 101108059

(51) Int. Cl. G06F 17/00; H04N 5/93

(52) U.S. Cl. 386/201; 700/94; 386/E05.029

(57) ABSTRACT

An exemplary audio guiding method includes obtaining signals transmitted by one booth/spot. The method analyzes and determines an identifier contained in the signal, determines an audio file corresponding to the determined identifier according to a stored first table, and obtains the determined audio file from a storage unit. Next, the method determines whether the obtained signals contain the exhibiting information of the exhibit. If yes, the method determines the playing time point of the obtained audio file corresponding to the exhibiting information of the exhibit according to the stored first table. The method then controls an audio playing unit to play the obtained audio file from the determined playing time point.

### BACKGROUND

1. Technical Field

The present disclosure relates to audio guiding devices and, more particularly, to an audio guiding device capable of guiding towards a dynamic exhibit and an audio guiding method.

2. Description of Related Art

Audio guiding devices of related art can introduce exhibits being exhibited in an exhibition. When the distance between a user with his audio guiding device and a booth/spot of the exhibition is less than a preset distance, the guiding device will play a corresponding audio file from the beginning to the end to introduce the exhibit shown at the exhibition booth/spot. However, when the exhibit is dynamically showed on one booth/spot, the currently exhibited content of the exhibit will not correspond to the played content of the audio file, thus the user may not get the introduction corresponding to the currently shown content of the exhibit. Therefore, it is desired to provide an audio guiding method to resolve the above problem.

### BRIEF DESCRIPTION OF THE DRAWINGS

The components in the drawings are not necessarily drawn to scale, the emphasis instead being placed upon clearly illustrating the principles of the audio guiding device and audio guiding method. Moreover, in the drawings, like reference numerals designate corresponding parts throughout the several views.

FIG. 1 is a block diagram of a guiding device in accordance with an exemplary embodiment.

FIG. 2 is a flowchart of an audio guiding method in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

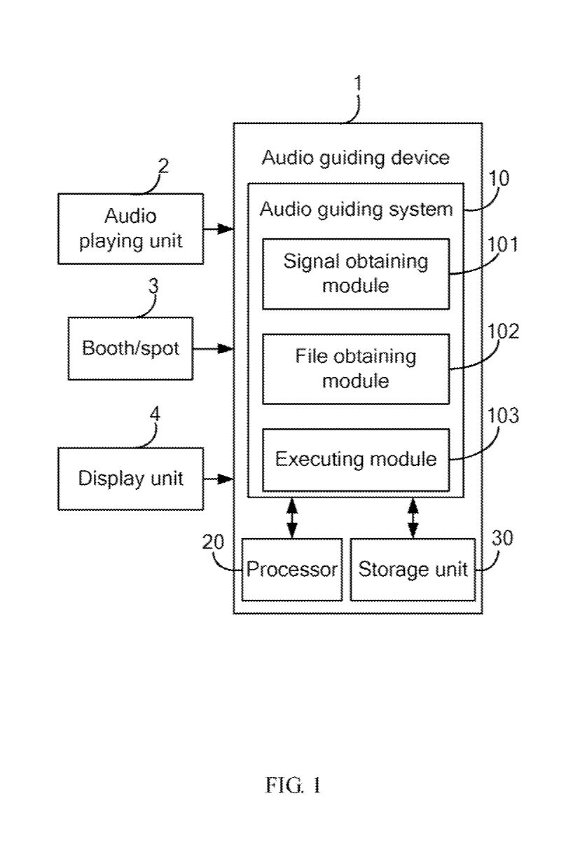

FIG. 1 shows an audio guiding device 1 in accordance with an exemplary embodiment. The audio guiding device 1 is connected to an audio playing unit 2. The audio guiding device 1 is carried by a user. The audio guiding device 1 can receive signals sent from a booth/spot 3, in an exhibition, for example, and control the audio playing unit 2 to audibly introduce the exhibit shown on the booth/spot 3. The exhibit can be a static exhibit or a dynamic exhibit. When the distance between the user and the booth/spot 3 is less than a preset value, the booth/spot 3 automatically sends a signal containing an identifier of the exhibit to the audio guiding device 1. The identifier of the exhibit represents the exhibit shown on the booth/spot 3. In the embodiment, the identifier can be character or number.

When the exhibit being shown on the booth/spot 3 is the dynamic exhibit, the signal sent from the booth/spot 3 further contains exhibiting information of the exhibit. The exhibiting information of the exhibit is used to indicate which stage of the dynamic exhibit is being shown at the moment. The exhibiting information may be playing time point or content corresponding to the stage of the dynamic exhibit which is being shown at the moment. In alternative embodiment, when the exhibit shown on the booth/spot 3 is the dynamic exhibit, the booth/spot 3 first transmits a signal containing only the identifier to the audio guiding device 1, and when the audio guiding device 1 determines that the exhibit corresponding to the identifier is the dynamic exhibit, the audio guiding device 1 feeds a signal back to the booth/spot 3, the booth/spot 3 then sends a signal which contains the exhibiting information of the exhibit to the audio guiding device 1.

The audio guiding device 1 includes an audio guiding system 10, a processor 20, and a storage unit 30. In the embodiment, the audio guiding system 10 includes a signal obtaining module 101, a file obtaining module 102, and an executing module 103. One or more programs of the above function modules may be stored in the storage unit 30 and executed by the processor 20. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The storage unit 30 further pre-store a number of audio files. The storage unit 30 further stores a first table and a second table. The first table records an identifier of each of at least one dynamic exhibit corresponding to one of the audio files, the exhibiting information of the dynamic exhibit, and playing time points of the corresponding one of the audio files corresponding to the exhibiting information. For example, a first recording “identifier: 5, exhibiting information: 8:30/bridge, playing time point of one audio file: 12 minutes 6 seconds of audio file 3” represents that audio content from 12 minutes 6 seconds of audio file 3 corresponds exhibit content from 8:30 of the dynamic exhibit, or audio content from 12 minutes 6 seconds of audio file 3 correspondingly introduces a bridge of the dynamic exhibit. The second table records an identifier of each of at least one static exhibit and one of the audio files associated with the static exhibit. In another embodiment, the first table and the second table can be combined in one table.

First table

| | Exhibiting | |
|---|---|---|
| Identifier | information | Playing time point of one audio file |
| 5 | 8:30/bridge | 12 minutes 6 seconds of audio file 3 |
| | . . . | . . . |
| | 8:50/gloriette | 18 minutes 5 seconds of audio file 3 |
| | . . . | . . . |
| . . . | . . . | . . . |
| 7 | 7:30/river | 12 minute 3 second of audio file 6 |
| | . . . | . . . |
| | 9:20/flower | 20 minute 10 second of audio file 6 |

Second table

| Identifier | Audio file |
|---|---|
| 3 | Audio file 1 |
| . . . | . . . |
| 8 | Audio file 2 |

The signal obtaining module 101 obtains the signals transmitted by a booth/spot 3.

The file obtaining module 102 analyzes and determines the identifier contained in the signals, determines the audio file corresponding to the determined identifier according to the stored first table and the second table, and obtains the determined audio file from the storage unit 30.

The executing module 103 determines whether the obtained signals contain the exhibiting information of the exhibit. When the signals contain the exhibiting information of the exhibit, namely, the exhibit is a dynamic exhibit, the executing module 103 determines the playing time point of the obtained audio file corresponding to the exhibiting information of the dynamic exhibit according to the stored first table, and controls the audio playing unit 2 to play the obtained audio file from the determined playing time point.

When the obtained signals do not contain the exhibiting information of the exhibit, namely, the exhibit is a static exhibit, the executing module 103 controls the audio playing unit 2 to play the obtained audio file from the beginning to the end.

In the embodiment, the storage unit 30 further stores a number of video files, corresponding to the audio files. The audio guiding device 1 further connects to a display unit 4. When the file obtaining module 102 obtains the determined audio file from the storage unit 30, the file obtaining module 102 further obtains one or more video files corresponding to the obtained audio file. When the executing module 103 controls the audio playing unit 2 to play the obtained audio file, the executing module 103 further controls the display unit 4 to synchronously display the obtained one or more video files.

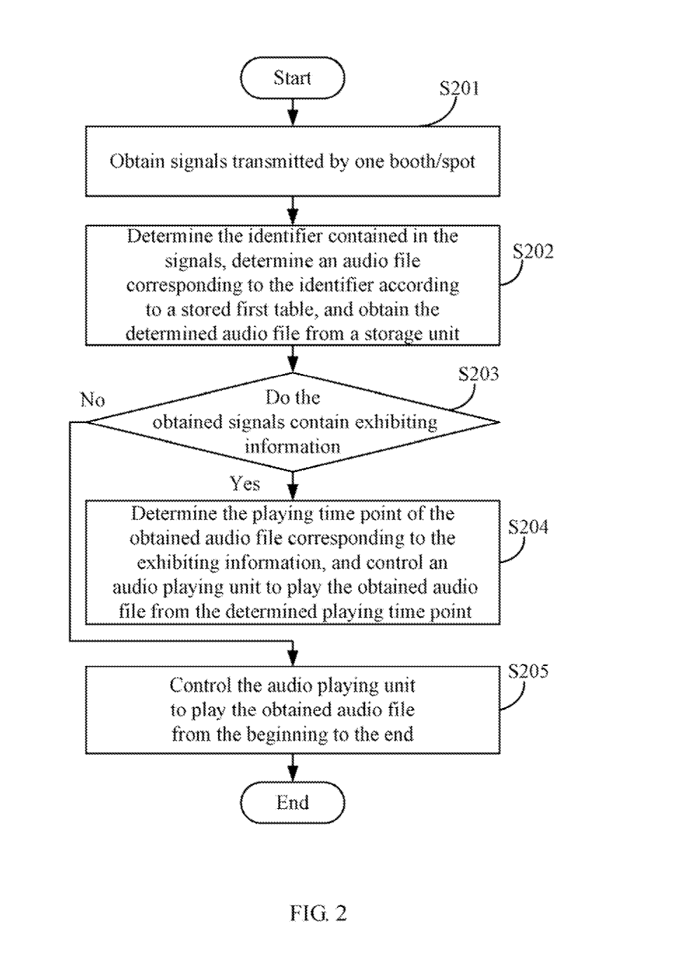

FIG. 2 shows an audio guiding method in accordance with an exemplary embodiment.

In step S201, the signal obtaining module 101 obtains the signals transmitted by a booth/spot 3.

In step S202, the file obtaining module 102 analyzes and determines the identifier contained in the signals, determines the audio file corresponding to the determined identifier according to the stored first table and second table, and obtains the determined audio file from the storage unit 30.

In step S203, the executing module 103 determines whether the obtained signals contain the exhibiting information of the exhibit. When the obtained signals contain the exhibiting information of the exhibit, the procedure goes to step S204. When the obtained signals do not contain the exhibiting information of the exhibit, the procedure goes to step S205.

In step S204, the executing module determines the playing time point of the obtained audio file corresponding to the exhibiting information of the exhibit according to the stored first table, and controls the audio playing unit 2 to play the obtained audio file from the determined playing time point.

In step S205, the executing module 103 controls the audio playing unit 2 to play the obtained audio file from the beginning to the end.

In the embodiment, the audio guiding method further includes: the file obtaining module 102 further obtains the one or more video files corresponding to the audio file from the storage unit 30 when the file obtaining module 102 obtains the audio file from the storage unit 30. The executing module 103 further controls the display unit 4 to synchronously display the obtained video files when the executing module 103 controls the audio playing unit 2 to play the obtained audio file.

Although the current disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An audio guiding device comprising:
a storage unit storing at least one audio file and a first table recording an identifier of each of at least one dynamic exhibit corresponding to one of the at least one audio file, exhibiting information of the dynamic exhibit, and playing time points of the corresponding one of the at least one audio file corresponding to the exhibiting information;
a processor; and
a plurality of programs stored in the storage unit, executable by the processor, the plurality of programs comprising;
a signal obtaining module operable to obtain at least one signal transmitted by a booth/spot;
a file obtaining module operable to determine an identifier contained in the at least one signal, determine the audio file corresponding to the determined identifier according to the stored first table, and obtain the determined audio file from the storage unit; and
an executing module operable to determine whether the obtained at least one signal contains exhibiting information of the exhibit, determine the playing time point of the obtained audio file corresponding to the exhibiting information of the exhibit according to the stored first table when the at least one signal contains the exhibiting information of the exhibit, and control an audio playing unit to play the obtained audio file from the determined playing time point.

2. The audio guiding device as described in claim 1, wherein the storage unit further stores a second table recording an identifier of each of at least one static exhibit and one of the at least one audio file associated with the static exhibit, the obtaining module is further to determine the identifier contained in the obtained at least one signal, determine the audio file corresponding to the determined identifier according to the stored second table, and obtain the determined audio file from the storage unit, the executing module is further to control the audio playing unit to play the obtained audio file from the beginning to the end when the obtained at least one signal does not contain the exhibiting information of the exhibit.

3. The audio guiding device as described in claim 1, wherein the storage unit further stores at least one video file corresponding to the at least one audio file, the file obtaining module is further to obtain one or more video files corresponding to the audio file from the storage unit when the file obtaining module obtains the audio file from the storage unit, the executing module is further to control a display unit to synchronously display the obtained one or more video files when the executing module controls the audio playing unit to play the obtained audio file.

4. An audio guiding method comprising:
obtaining at least one signal transmitted by a booth/spot;
determining an identifier contained in the at least one signal, determining an audio file corresponding to the determined identifier according to a stored first table which records an identifier of each of at least one dynamic exhibit corresponding to one of the at least one audio file, exhibiting information of the dynamic exhibit, and playing time points of the corresponding one of the at least one audio file corresponding to the exhibiting information, and obtaining the determined audio file from a storage unit; and
determining whether the obtained at least one signal contains exhibiting information of the exhibit, determining the playing time point of the obtained audio file corresponding to the exhibiting information of the exhibit according to the stored first table when the at least one signal contains the exhibiting information of the exhibit, and controlling an audio playing unit to play the obtained audio file from the determined playing time point.

5. The audio guiding method as described in claim 4, wherein the method further comprises:
determining the audio file corresponding to the determined identifier according to a stored second table which records an identifier of each of at least one static exhibit and one of the at least one audio file associated with the static exhibit, and obtaining the determined audio file from the storage unit; and
controlling the audio playing unit to play the obtained audio file from the beginning to the end when the obtained at least one signal does not contain the exhibiting information of the exhibit.

6. The audio guiding method as described in claim 4, wherein the method further comprises:
obtaining one or more video files corresponding to the audio file from the storage unit when obtaining the audio file from the storage unit; and
controlling a display unit to synchronously display the obtained one or more video files when controlling the audio playing unit to play the obtained audio file.

7. A non-transitory storage medium storing a set of instructions, the set of instructions capable of being executed by a processor to perform an audio guiding method, the method comprising:
obtaining at least one signal transmitted by a booth/spot;
determining an identifier contained in the at least one signal, determining an audio file corresponding to the determined identifier according to a stored first table which records an identifier of each of at least one dynamic exhibit corresponding to one of the at least one audio file, exhibiting information of the dynamic exhibit, and playing time points of the corresponding one of the at least one audio file corresponding to the exhibiting information, and obtaining the determined audio file from a storage unit; and
determining whether the obtained at least one signal contain exhibiting information of the exhibit, determining the playing time point of the obtained audio file corresponding to the exhibiting information of the exhibit according to the stored first table when the at least one signal contains the exhibiting information of the exhibit, and controlling an audio playing unit to play the obtained audio file from the determined playing time point.

8. The non-transitory storage medium as described in claim 7, wherein the method further comprises:
determining the audio file corresponding to the determined identifier according to a stored second table which records an identifier of each of at least one static exhibit and one of the at least one audio file associated with the static exhibit, and obtaining the determined audio file from the storage unit; and
controlling the audio playing unit to play the obtained audio file from the beginning to the end when the obtained at least one signal does not contain the exhibiting information of the exhibit.

9. The non-transitory storage medium as described in claim 7, wherein the method further comprises:
obtaining one or more video files corresponding to the audio file from the storage unit when obtaining the audio file from the storage unit; and
controlling a display unit to synchronously display the obtained one or more video files when controlling the audio playing unit to play the obtained audio file.
